(19) United States
(12) Patent Application Publication
(10) Pub. No.: US 2008/0244003 A1
(43) Pub. Date: Oct. 2, 2008

(54) Methods and Apparatus for Creating Enhanced Receptivity for Material in Learning, Problem-Solving and Life-Style Improvement

(76) Inventors: Bruce Springer, Livermore, CA (US); Mathew Tenuta, Livermore, CA (US)

Correspondence Address: CENTRAL COAST PATENT AGENCY, INC, 3 HANGAR WAY SUITE D, WATSONVILLE, CA, 95076, US

(21) Appl. No.: 12/058,296

(22) Filed: Mar. 28, 2008

Related U.S. Application Data
(60) Provisional application No. 60/908,861, filed on Mar. 29, 2007.

(51) Int. Cl. G06F 15/16; G06F 17/00

(52) U.S. Cl. 709/203; 700/94

(57) ABSTRACT

A system for acquisition and presentation of audio or audio/visual media has a peripheral computing device including an audio speaker system, a visual display screen and a memory for storing the media, the device having connection access to a computer connected to a network and output connection access to one or more light emitting devices, and a personalized content page stored in a server connected to the network and accessible to the peripheral computing device, the page including the page content encrypted for use solely by the peripheral computing device. A user operating the device while plugged into the network-connected computer may invoke a universal resource locator on the device to cause navigation to the personalized content page through the network-connected computer as a host.

### CROSS-REFERENCE TO RELATED APPLICATIONS

The present invention claims priority to a U.S. provisional patent application Ser. No. 60/908,861, entitled Method and Apparatus for Creating Enhanced Receptivity for Material in Learning, Problem-Solving and Lifestyle Improvement, filed on Mar. 29, 2007, disclosure of which is incorporated herein in its entirety by reference.

### BACKGROUND OF THE INVENTION

1. Field of the Invention

This invention is in the field of learning techniques and systems, and pertains particularly to systems for creating in users a more receptive mood or attitude during periods of audio and visual content acquisition.

2. Discussion of the State of the Art

It is quite well-known that a person learns through audio and visual input. It is also well-known that a person's attitude and mood affects that person's ability to acquire and retain new material. Many environmental conditions and stimuli affect mood and attitude—for example music, poetry, surf sounds and lighting in the immediate environment.

New and better ways to condition a human subject to learn more efficiently are a valuable addition to the art. Relaxation audio music has long been a proven commodity in the market place. A wide variety of audio stimuli is generally available to the public consumer for the purpose of aiding in virtually any endeavor or in the attainment of any goal that the consumer may desire. Hypnosis and similar therapies have long been practiced in the art to help guide individuals toward ultimate goals. Helping the individual to eliminate wasteful or negative energies is an intrinsic part of the process. In the medical professions, more and more clinical trials and studies are showing that the benefits of adjuvant therapies that incorporate realization techniques, foster positive thinking, provide hope, or just provide a relaxed and meditative environment are real and can be tapped to improve overall health and well being of an individual.

Many clinics, resorts, spas, and similar facilities incorporate some kind of mood elevating, motivational, or meditative experience whether audio, visual or a combination thereof for the benefit of their patrons. One of these techniques involves the well known study of Binaural Beat generation to produce three dimensional pulses that entrain brainwaves to follow a certain frequency associated with Beta, Alpha, Theta, or Delta brainwave frequencies. A drawback to current state-of-art systems is that the environmental natures or in some cases technological presentations relative to those systems is geographically bound to the geographies or physical domains supporting those systems. Consumers in general may find it very difficult if not impossible to be able recreate these systemically beneficial therapies in a way that is practical and immediately available.

It has occurred to the inventor that many persons could benefit from an economically practical and technically feasible presentation of a combination of carefully orchestrated audio and visual stimuli such as could be had whenever and wherever the consumer desires.

Therefore, what is needed in the art is a system for presenting and consuming lifestyle enhancing audio and visual stimuli that is portable and can be accessed and practiced by users according to demand at any time.

### SUMMARY OF THE INVENTION

A problem stated above is that portability and flexibility are desirable for a media-based lifestyle enhancement system, but many of the conventional means for acquiring lifestyle-enhancement media-based experiences, such as in a clinic, are stationary, fixed systems requiring the active presence of the user onsite. The inventors therefore considered functional elements of a media-based lifestyle enhancement system and services, looking for elements that promote portability and flexibility in media acquisition that could potentially be harnessed to provide an experience but in a manner that would not be limiting on the consumer as to where or when such an experience could be available.

Every media-based lifestyle enhancement system relies on equipment for creating media, for making the media available, and for presenting the media to the consumer. The present inventor realized in an inventive moment that if, at the point of access of the media, a portable device could be provided for completely containing and playing the media, significant increase in consumer independence and flexibility might result. The inventor therefore constructed a unique hand-held media playback device and media delivery service that allowed consumers to experiment freely with offered lifestyle enhancement media and made the experience portable and available to the consumer on demand. A significant improvement in availability of media to consumers and revenues to service providers is seen with no noticeable degradation of quality of services.

Accordingly, the inventors provide a system for acquisition and presentation of audio or audio/visual media. The system includes a peripheral computing device including an audio speaker system, a visual display screen and a memory for storing the media, the device having connection access to a computer connected to a network and output connection access to one or more light emitting devices, and a personalized content page stored in a server connected to the network and accessible to the peripheral computing device, the page including the page content encrypted for use solely by the peripheral computing device. The system is characterized in that a user operating the device while plugged into the network-connected computer may invoke a universal resource locator on the device to cause navigation to the personalized content page through the network-connected computer as a host.

According to another embodiment of the invention, the inventor provides a peripheral computing system for playback of audio or audio/visual media. The system includes a communication port for enabling peripheral device communication with a host computer, audio/visual media presentation circuitry and software for playing audio files and for displaying graphics, a memory for storing audio/visual media files, and one or more device-controlled light emitting devices. The system is characterized in that a user operating the device may connect to a personalized content page through the host computer and access audio or audio/visual media wherein the audio portion of the media contains pulses set to certain frequencies that are decoded by the device for use in controlling illumination of the one or more light emitting devices.

According to another embodiment, an audio or audio/visual media file is provided and includes a sequence of music or sounds, and one or more sequences of embedded pulses audible or not audible mixed in with the sequence of music or sounds. The embedded pulses occur at one or more frequencies during playback and are electronically detectable by a playback device, the pulses used to drive one or more light emitting devices connected to or accessible to the playback device.

In one aspect of the invention, a method is provided for controlling one or more illumination devices coupled to or integrated with a hand-held music player by one or more sequences of tones or pulses generated by a digital audio presentation played on the device comprising the steps, (a) providing a voltage controlled oscillator on the hand-held device as a circuit having a voltage input and a voltage output, (b) connecting the voltage input of the oscillator to an audio decoder adapted to decode and play the audio presentation, (c) connecting the voltage output of the oscillator to a power control switch or an intensity control switch that provides power or light intensity control to the one or more illumination devices, and (d) playing the audio presentation on the hand-held device.

In still another aspect of the present invention, a method is provided for conducting a personal media access session through an Internet-connected computer using a peripheral device having a graphics display screen comprising the steps, (a) establishing a communication link between the peripheral device and the computer, (b) on the peripheral device, invoking a universal resource locator specific to an electronic information page containing access links to media, (c) invoking as a result of the action of step (b), the browser on the computer to navigate to and display the electronic information page, (d) from the peripheral device, selecting from the links in the content page causing download of specific media to the peripheral device and (e) after download of the media, terminating the session by controlled action performed from the peripheral device, or by disconnecting the device from the Internet-connected computer.

### BRIEF DESCRIPTION OF THE DRAWING FIGURES

FIG. 1 is an architectural overview of a media access network according to an embodiment of the present invention.

FIG. 2A is a front view of a media playback device according to one aspect of the invention.

FIG. 2B is a top view of the device of FIG. 2A.

FIG. 2C is a left side view of the device of FIG. 2A.

FIG. 2D is a right side view of the device of FIG. 2A.

FIG. 3 is block diagram illustrating components of the device of FIG. 2A according to an embodiment of the present invention.

FIG. 4 is a process flow chart illustrating steps 400 for accessing media from the device of FIG. 2A according to one aspect of the present invention.

FIG. 5 is a process flow chart illustrating steps 500 for playing a media selection using the device of FIG. 2A.

### DETAILED DESCRIPTION

The inventor provides a service and system for enabling personal access to life-style enhancement media materials using a personalized playback device and secure Web services to deliver and consume the media. Methods and apparatus of the invention are described in the following exemplary embodiments.

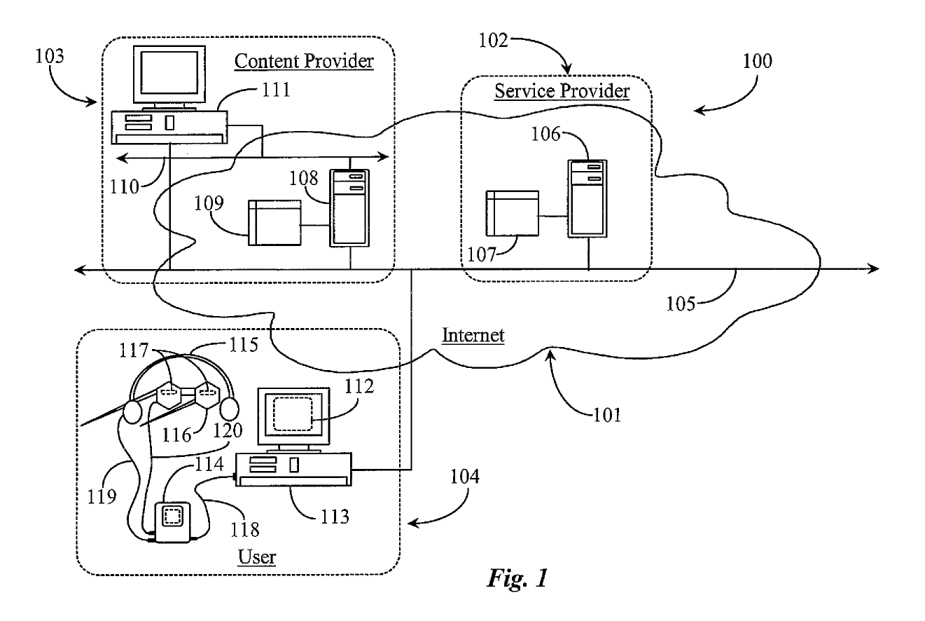

FIG. 1 is an architectural overview of a media access network 100 according to an embodiment of the present invention. Media access network 100 comprises at least one primary carrier network 101, which is the Internet network in this embodiment. The inventor chooses the Internet network as a primary network over which media relative to life-style enhancement may be accessed because of its high public access characteristic and geographic reach. Network 101 will hereinafter be referred to in this specification as Internet 101.

Internet 101 is also defined herein by a network backbone 105 that is intended to represent all of the lines, equipment, and access points that make up the Internet network as a whole including any connected sub networks used to gain access. Therefore, there are no significant geographic limitations to the practice of the present invention at least from the standpoint of Internet access coverage. Network 101 may be a corporate wide-area-network (WAN), a local-area-network (LAN), a municipal access network (MAN), or some other construction of one or more connected networks without departing from the spirit and scope of the present invention.

Internet network 101 serves as a host network for media compiled by a service provider such as a service provider 102 illustrated herein. Service provider 102 is adapted to provide consumer access to content acquired from content providers such as a content provider 103 illustrated in this example. A user domain illustrated herein as user 104 represents any consumer of digital content, more particularly of content provided through service provider 102.

Service provider 102 may be any entity that is enabled by the invention to provide consumer access through Web-based services to media content such as through an electronic information server or Web server 106. Web server 106 may be a public access portal or public access interface through which specific media selections might be purchased, downloaded, and then played by the user or consumer associated, perhaps by subscription services to service provider 102.

Portal 106 is connected to network backbone 105 and may be made accessible to the public and may serve information pages in HTML or other supported formats. Such Web pages may include service registration and account management pages as well as secure pages for transacting and pointing to content. In this example, a multimedia data repository 107 is provided within the domain of service provider 102 and is illustrated as coupled to portal 106. Repository 107 may hold data on existing clients of the service such as account information, purchase history, billing information, and so on. Repository 107 may also hold multimedia content for distribution or download.

Multiple dedicated servers as well as data stores and multimedia repositories can be provided within domain 102 without departing from the spirit and scope of the invention. The inventor illustrates just a single server and connected repository and deems the illustration sufficient for the purposes of explaining the invention. Likewise, there may be multiple service providers such as provider 102 available to a consumer without departing from the spirit and scope of the present invention.

In one embodiment of the present invention, service provider 102 makes content available to consumers wherein the content is stored externally from the provider domain. Content provider 103 represents any of multiple disparate entities that may prepare multimedia content according to aspects of the present invention where that content is consumable through one or more service providers like service provider 102. Content provider 103 has a multimedia content server 108 illustrated herein as connected to network backbone 105. Multimedia server 108 is adapted to serve multimedia files on request or as part of a service agreement with service provider 102.

A multimedia repository 109 is illustrated in this example and is connected to server 108. Repository 109 is adapted to hold multimedia presentations, particularly life-style-enhancing presentations, that may be audio or audio/visual presentations. Such presentations may be prepared according to an embodiment of the present invention to be accessed through service provider 102 by consumers practicing the present invention.

A computer station 111 is provided within the domain of content provider 103 and is adapted by software to create digital audio or audio visual presentations including digital mixing of music, audio sounds, sub-audio pulses or tones and super-audio pulses or tones. In one embodiment, such presentations may include binaural beats, pulses, or the like generated at specific frequencies relative to brain wave frequencies of Alpha, Beta, Gamma, and Delta frequencies. Binaural beat generation is an art well known to and available to the inventor. Software for creating audio or audio/visual presentations may be accessed from or otherwise acquired for use by content providers such as provider 103 from service provider 102. In this way, content from provider 103 may be presented in a format proprietary to the service provider.

Computer station 111 is connected to a LAN 110 provided within the physical domain of the content provider. LAN-connected computer station 111 may have indirect or direct access, as illustrated herein, to network backbone 105. Multimedia files created at station 111 may be deposited for use in repository 109 and served over the Internet by multimedia server 108. A content provider may be engaged in or may specialize in any facet of life-style or life-enhancing activities such as meditation, health, learning, wealth, or any other approved life improvement media content. In one embodiment of the present invention, content providers are approved for content before they are enabled to create content using proprietary software for encoding and encrypting content for consumers of the service of the invention.

A user domain 104 is illustrated in this embodiment and represents a domain available to any consumer authorized to practice the invention. User domain 104 (User) may subscribe to the service of the present invention and may, as part of the service, purchase or otherwise obtain a special media playback device illustrated within user domain 104 as a media playback device 114. Media playback device 114 is a computerized media player with a graphics display-capable screen such as a liquid crystal display (LCD).

Device 114 may be used as a computer peripheral device and can be coupled to a networked computer capable of accessing Internet 101 as is the case in this embodiment. A networked computer 113 is illustrated within user domain 104 and has Internet access to network 101 by any conventional method such as digital subscriber line (DSL), cable/modem, dial-up access, broadband, or T1 connection. In this example, media playback device 114 connects to computer station 113 by way of a universal serial cable 118. Other methods may also be used to enable device 114 as a computer peripheral device such as infrared wireless, Bluetooth™, Wireless Fidelity (WiFi), etc. In this case, a high speed USB link is established between the device and computer station 113.

Device 114 is enabled by software (not illustrated) to leverage the Internet access services provided on computer 113 to access services offered through service provider 102 in a secure and uniquely personalized way. Computer station 113 has connection by way of Internet access line to backbone 105 enabling device 114 to access server 106 by invoking a universal resource locator from the device that is uniquely issued to the device as part of the service of the invention.

In one embodiment, each consumer authorized to access server 106 is an authorized subscriber to the service of the present invention and has a unique and personalized access code and URL to a personalized Web page hosted on server 106. In this embodiment media device 114 is activated by download of the unique access code and URL so that only device 114 owned by a particular subscriber may access the Web page hosted for that particular subscriber. No other device 114 may access the same page unless authorized by the device owner and service subscriber. The personal access code may be a combination of an identifier of the device and a unique URL created specifically for that device. In this case, no login is required for device 114 to access the Web page assigned to the device. Server 106 recognizes device 114 upon connection request and serves the appropriate secure Web page.

Media playback device 114 has audio output to an audio headset 115 by way of an audio output cable 119 and an appropriate output jack. An ear bud or set of standard speakers may also be used. The audio output may also be extended to a stereo or other entertainment system having output audio speakers. Playback device 114 also has a voltage output to a special eyewear 116 that includes one or more light emitting diodes 117 mounted strategically in the frame or directly on one or both eye lenses of eyewear 116. In this embodiment eyewear 116 is of the form of glasses although this is not specifically required in order to practice the present invention.

Strobe lights, LEDs, or other illumination devices may be controlled by device 114 and such devices may be external to device 114 or incorporated onto device 114 without departing from the spirit and scope of the present invention. However, one goal of the invention is to enable a consumer to have a practical and economical life-enhancement experience from a point of convenience to the consumer such as from home, from a mobile access point (automobile), library, or some other location comfortable and convenient to the consumer at the time. Hence, potable utilities such as LED eyewear, headsets, and the like are afforded to promote freedom from otherwise required presence of the user in a stationary facility of some type like a clinic, resort, or other service location.

Voltage output of media playback device 114 is provided for the purpose of controlling the illumination aspects of the connected light emitting devices 117 including “strobe enablement” of the devices by quickly turning them on and off. The voltage oscillation used to control light emitting devices 117 is deciphered from a media presentation (typically a digital file) being played on the device. Therefore, audio and light effects are available to a user operating the device to play a media presentation acquired through service provider 102. Light effects may also include voltage control of light intensity or color change as well as strobe effects if enabled. Graphics that are part of the digital media presentation can be displayed on the LCD of device 114 as well.

Although computer station 113 is illustrated in this example as a computer residing within the domain of the user, it does not have to be owned by the user. The only requirement for a computer host for device 114 is that it has access to Internet 101 and can be accessed by the playback device by USB or other method. For example, a public computer in a library or a friend's computer in another domain could serve as an adequate host station as long as it has connection to the Internet.

In practice of the invention, the user operating device 114 may connect the device to any Internet-connected terminal (computer, Laptop, etc.) and may then use the prevalent Internet navigation software to access a particular “device URL” by invoking the above-described access code assigned to the device. The URL/code may be provided as an executable link on device 114. The Web page server to the device may appear encrypted as encrypted page 112 on the display of computer station 113 in one embodiment, but may appear in a decrypted format as a page visible on the LCD of device 114. In one embodiment the Web page served to device 114 as a result of URL invocation does not appear on the display screen or monitor of computer 113 but does appear on the LCD of device 114 and may be interacted with from the point of the device.

In one embodiment, a Web page served to device 114 may be rendered human-readable in the display screen or monitor of computer station 113 and can be interacted with from the point of the computer station using typical computer input methods. In a preferred embodiment and because of the nature of the material, the service provider affords some degree of anonymity with respect to viewing and transporting content from a standpoint of encryption to protect the privacy of the consumer even when the consumer uses a public computer or one belonging to another person to access and download content. For example, a multimedia presentation from a content provider may be a motivational presentation about living with a specific type of cancer. The consumer may not wish that anyone including the owner of the host computer be able to determine that the user is downloading multimedia content relative to cancer to device 114. However, in some embodiment, these restrictions may be eased or eliminated altogether depending on the desires of the individual consumer. Therefore, the encryption/decryption of media content and Web page content might be configurable to attain the desired anonymity for the consumer.

Using computer station 113 as a host the consumer or “user” can access and play media from server 106 in real time while connected online. The user may also elect to download multimedia files and store them on device 114 using onboard memory or a removable memory such as a memory stick or storage device (SD). Device 114 may, in one embodiment, be adapted to facilitate a USB thumb drive by providing a USB port on the device.

Software installed on playback device 114 decrypts files that are downloaded to the device and decodes the multimedia for playback. Part of the decoding process includes detection and isolation of special beats, pulses, and/or tones embedded into the audio. These special beats, pulses, and/or tones may be used by the playback device to drive the LEDs on eyewear 116 in synchronization with the rest of the presentation. In one embodiment binaural beat generation is used to create beat or pulse sequences at specific frequencies that may be constant or may change strategically during a presentation, the frequencies inducing a frequency follow response (FFR) from a user's brainwave function. Using this technique in audible and visible presentation can help induce specific states in the user such as one or more of the four brainwave frequencies mentioned above. The exact programming of these beats, pulses and or tones depends on the content provider and goal of the life-style enhancement presentation being played at the time.

The personal Web page offered to device 114 may allow the user to access other services besides acquisition of content. For example, a secure transaction process may be provided so that a user may provide compensation to the service provider for the authorization to access for play or download of media selections. A user may be enabled through the unique Web page to view account status, to view purchase history, to make payments, to change payment information and contact details, and to configure privacy services. A main purpose for page 112 is to enable the user to select and acquire offered presentations from a larger number of available presentations aggregated by the service provider for selection.

In one embodiment, no proprietary software has to be provided to computer station 113 to practice the invention and after a session with device 114, there remains no record of any interaction including no temporary files, or other containers left over from the session. This may be accomplished in one embodiment, using an erasure tool loaded on device 114 that wipes over any records or files that may be left on the host station after a session like history files, document types, connection state data, virus check records and so on. In essence, device 114 erases its own foot print on the host station after each data session with server 106 made through that host.

In one embodiment, the host recognizes device 114 has a second drive and permits download activity directly to the drive bypassing the temporary file and cache memory structure of the host completely. In this case, the computer navigation history and other footprints may be written directly to device 114 instead of computer 113. The goal is anonymity for the consumer relative to any activity caused to occur as a result of connecting device 114 to station 113 and accessing a URL from server 106.

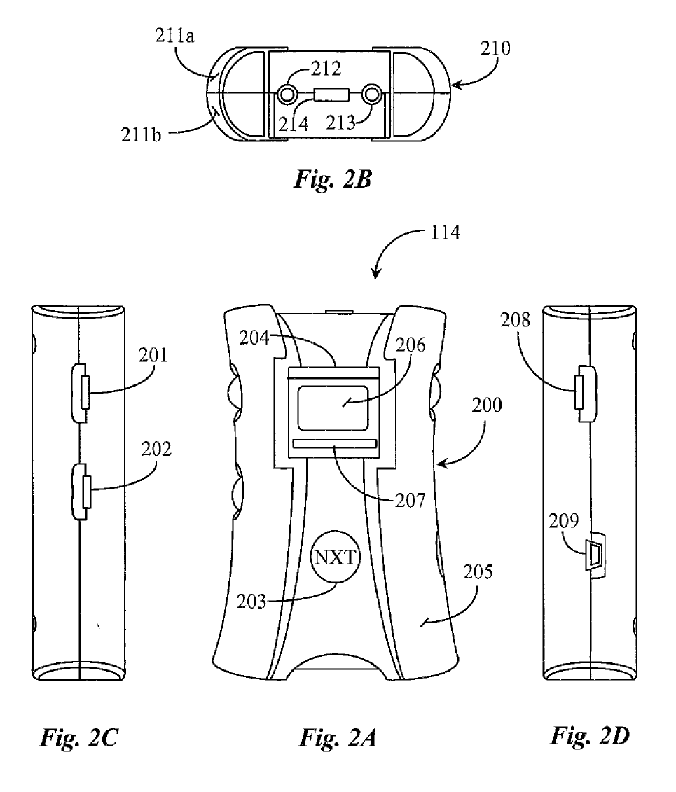

FIG. 2A is a front view of media playback device 114 according to one aspect of the invention. Media playback device 114 is a computerized device that may be comfortably held in a user's hand and may be comfortably operated by a user because of an ergonomic design 200 that lends to a bow-in feature for both sides of the device. The shape of the device fits more comfortably in a user's hand.

Device 114 has a device housing or casing 205 that may be manufactured of a durable polymer. Housing 205 may be provided in two pieces, a front and back housing that may be snapped together to enclose the components of device 114. Device 114 has a graphics display screen 204. Screen 204 may be an LCD screen or one of the newer organic polymer screens such as polymer light emitting device (PLED) or organic light emitting device (OLED). In this example, screen 204 is set down within a groove feature and presents below the top surface of the device and is not visible from the side of the device. In part, this is for privacy of the user of the device. Screen 204 is more difficult to view from the vantage point of an adjacent position.

Device 114 includes an area 203 for application of a trade name logo, in this case NXT™ the trade name provided by the inventors. In one embodiment, the device may be provided other names in such as co-branding agreements that may be implemented between the device provider and a service provider such as provider 102 described above.

Device screen 204 includes a graphics presentation 206 visible on the screen, such presentation including a title bar (top) and a control bar 207 (bottom). Control bar 207 may be manipulated using device input control to pause, play, stop, zoom, or delete a presentation. A mouse touchpad button or touch screen method can be included with the device for application of input for controlling playback features of the device and for performing other computerized tasks such as selecting media presentations listed on a Web page graphic that might be displayed on screen 204. Area 203 showing the device logo may also double as a mouse touchpad and scroll station for a fully functional and interactive graphics display.

FIG. 2B is a top view of device 114 of FIG. 2A. The sides of housing 205 assembled demonstrate a full radius 210 for further ergonomic comfort. Front housing 211a and rear housing 211b are labeled in this view. Device 114 includes an on/off/device lock feature 214. Feature 214 may be provided as a sliding switch, or as one or more electronic mode buttons. Device 114 includes at least two output jacks illustrated herein as an output jack 212 and an output jack 213. Output jack 212 may be an audio output jack to an external speaker or speaker set as described further above. Jack 213 may be an output jack for driving one or more external illumination devices like LEDs 117 mounted on eyewear 116 as described further above.

FIG. 2C is a left side view of device 114 of FIG. 2A. A set of user operable controls illustrated herein as a control 201 and a control 202 are accessible on the left side of device 114. Control feature 201 may be a simple volume control while control 202 may be an intensity control for brightness of display screen 204 described above. In this example, controls 201 and 202 are thumb wheels set into depressions molded into the device casing. In other embodiment other types of physical geometries may be used instead such as a pivot plate or a pair of mode buttons that are depressed.

FIG. 2D is a right side view of device 114 of FIG. 2A. A position tracking control 208 is provided on the right side of device 114. Tracking control 208 enables a user to track the progress of a presentation and then quit and resume the presentation without losing the position in the file. Tracing control 208 is a memory function of device 114 that works to remember the last position of a presentation that was closed on the device. The next time that presentation is opened on the device, an option for resuming the presentation where it left off is provided. This option can be overridden by the user. In some embodiments, control 208 may allow for tracking of more than one position in a presentation such as by creating one or more bookmarks at a certain positions in the file which later may be navigated to by depressing a button repeatedly (once to navigate to each sequential bookmark). Other typical controls such as loop, zoom, play, pause, stop, repeat, delete, save, equalizer controls, etc can be accessed through touchpad pointer device interaction with display screen 204 while a presentation is loaded and playing.

A USB port 209 is provided on the left side of device 114 is for enabling USB communication, charging, and file transfers between the device and a host device or an Internet-based server node such as node 106 of FIG. 1. There are multiple geometries that can be used to provide the pin configuration of a high-speed USB interface. The exact geometry used in this device is not relevant to the present invention. In other embodiments, a Bluetooth™ wireless transceiver, or a miniature wireless card slot may be provided for wireless communication between the device and a host. Line of sight infrared capability might also be included on the device.

A user may, with device 114 and connected accessories (headset, eyewear), experience lifestyle improvement or enhancement materials played on the device in a way that also provided the freedom of movement and choice of location when engaging the service. Portability of device 114 gives flexibility to the consumer and enables more activity with respect to multiple consumers accessing media from the service site on demand. Thus, the service is able to reach more individual consumers than with a fixed location facility benefitting consumers, content providers and the service providers.

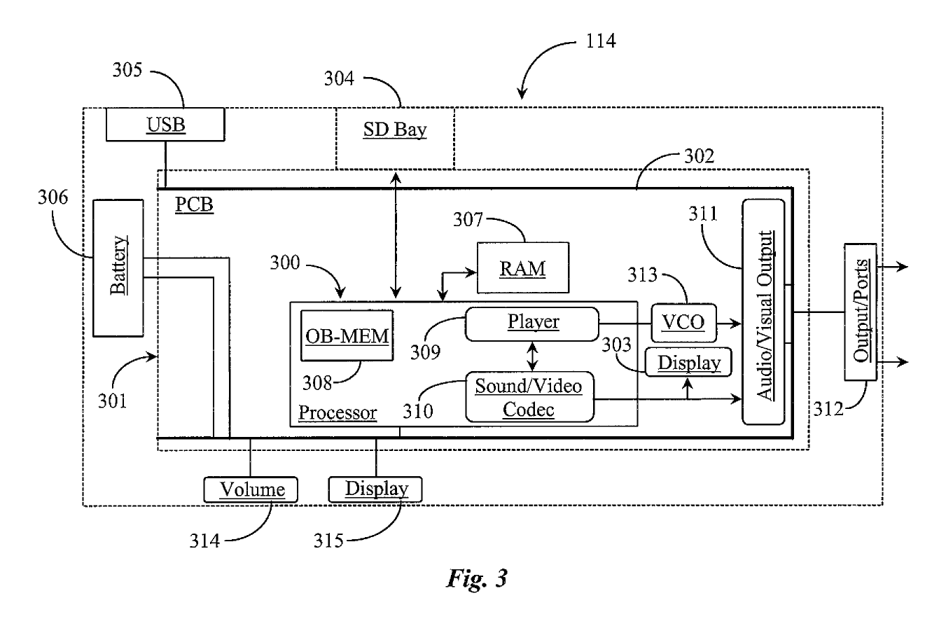

FIG. 3 is block diagram illustrating components of a computerized device analogous to device 114 of FIG. 2A according to an embodiment of the present invention. Device 114 is a computerized device and contains many of the basic components of such devices. A printed circuit board (PCB) 301 is provided to support a logical computer bus structure 302 provided for inter-component communication. Device 114 may include a battery compartment 306 for batteries. USB port 305 may be used to provide charge to a battery or batteries in compartment 306.

Device 114 has a processor 300. Processor 300 supports on onboard memory (OB-MEM) 308. MEM 308 may be adapted to store firmware and software enabling device function, for example, an operating system, browser, or other optional software features. A media player application 309 is provided and illustrated logically herein. Media player 309 has access to sound and video codec for decoding digital files and playing those files. Sound/video codec 310 may also include decryption firmware for decrypting an encrypted media file before playback.

Device 114 may include a random access memory (RAM) 307 illustrated as connected to processor 300. Optionally, a storage device bay (SD Bay) 304 may be provided for docking a removable storage device. Processor 300 has direct access to SD bay 304. Device 114 may contain both volatile memory such as cache memory and non-volatile memory such as a flash memory without departing from the spirit and scope of the present invention.

Device 114 has output ports 312, which are analogous to output jacks 212 and 213. Audio visual output circuitry 311 is provided to support output audio output and control for visual strobe or other effect of one or more connected illumination devices such as the above-described LEDs.

A voltage controlled oscillator (VCO) 313 is provided to process generated beat or pulse data from a digital presentation into voltage signals for controlling the illumination device effects. Sound codec provides audible sound and video codec provides the graphics data to a display circuitry 303. User control circuit volume (314) and display circuit (315) are illustrated in this example. Control circuits 314 and 315 are analogous to controls 201 and 202 of FIG. 2C. Display circuit 315 may be an intensity adjustment circuit like that of a brightness control used to increase or to decrease the brightness level of the display screen of the device.

In practice, output from player 309 such as sub audio tones, super audio tones, or binaural beats or pulses are detected by the player separately from the played content as a presentation is played. This data is sent into VCO 313, which provides the control signaling for manipulation external illumination devices. Sound and video is sent to display circuit 303 for screen display and audio output of audible music and/or sounds. Digital multimedia files for presentation may be downloaded to MEM 308 or to an SD docked into bay 304. Real time presentation may also be facilitated using RAM 307 to cache temporary information before playing the selection. Downloaded files may be stored on the device in OB-MEM 308 and may be played at any later time. Files may also be stored on an SD card and may be played at any time.

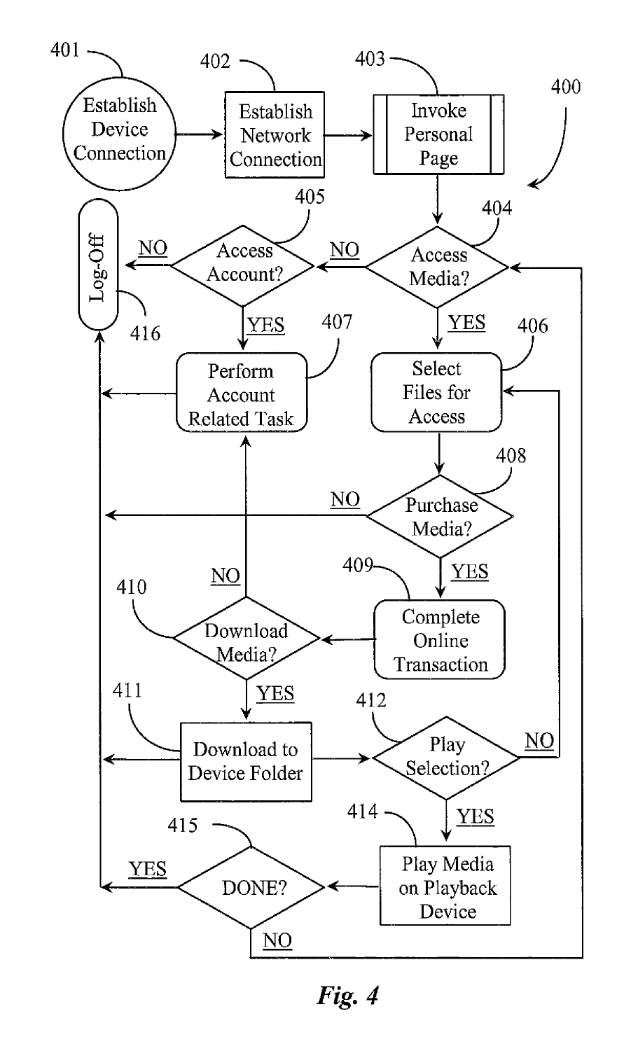

FIG. 4 is a process flow chart illustrating steps 400 for accessing media from the device of FIG. 2A according to one aspect of the present invention. At step 401a user establishes a connection between the playback device and a computer host. The connection established may be a USB connection or a wireless connection. At step 402 the user verifies a network connection such as a live Internet connection on the host computer. The device may only be able to access the network if the computer host is already connected to the network. In one embodiment, the device has permission from the host to establish an Internet connection by manipulating the connection facility on the host computer.

At step 403 the personal page URL of the device is invoked and the device is served a Web page, for example, that is only available to the device. In this case, login may not be required of the user because the server immediately recognizes the device and URL requested by the device. In another embodiment, verification may still be required as an extra measure of security that the device, for example, is not being used by an unauthorized person to gain access to the personal Web page.

At step 404 the user has the option of accessing media. At this point the Web page may be displayed on the device display screen and, perhaps on the display of the host computer. The host display may be encrypted and may not be human readable. In one embodiment, the personal page is served encrypted and can only be decrypted on the playback device.

If at step 404 the user decides not to access media, then an option for accessing the user account may be presented. Account access may include access to a number of user options such as making payments, updating account information, or other like tasks. If at step 405, the user decides that no action will be undertaken at the site, the user may log off of the site at step 416 without doing anything. If at step 405 the user elects to access the user account, then the user account page can be served and the user can perform one or more account-related tasks at step 407. Account-related tasks may also include any configuration tasks allowed such as configuring security or anonymity levels for media playback. After completing the account-related task or tasks, the user may log off of the server at step 416. An option on an account page may enable the user to navigate back to a main page for accessing media.

At step 404 if the user decides to access media, then a page containing a catalog or a scrollable listing of hyperlinked media selections may be served to the user. In one of several different ways the user may at step 406, select one or more media files for access. In one embodiment, the user may have a container into which selections can be dragged and dropped over to initiate download of the presentations. In one embodiment selections are highlighted for downloading or can be doubled clicked to stream the file to the device while online.

An option for purchasing the media may be presented to the user at step 408 before an un-purchased media selection can be downloaded or played. If the user decides not to purchase the media selected at step 406, then the user may log off of the server at step 416. Step 408 may be repeated for more than one item selected or highlighted. If at step 408 the user decides to purchase a selected presentation, an online transaction may be presented and completed at step 409. In one embodiment, the user may have pre-paid credit with the service and presentations are automatically paid for pending account balance available at the service.

An option for downloading the media may be presented if one or more presentations are successfully purchased at step 409. If at step 410 the user decides not to download the media to the device, then the user may or may not perform some auxiliary account related task at step 407, which may include moving the files into a download section for future download. After such activity the user may log off of the system at step 416. If at step 410 the user decides to download the purchased media for consumption, the user may initiate media download at step 411. Downloaded media may be saved in a device folder for later access or on a removable SD card or thumb drive if the device is equipped to host such devices.

Media presentations are encrypted and encoded for the player on the device and not for any other player. Only the device player can decrypt decode and play a media presentation. In one embodiment at least for encrypted media files, the encryption scheme incorporates some device or user data in the process so that another similar device could not be used to play a media selection belonging to another user without permission and perhaps a decryption key provided by the user.

At step 412 the user may decide to playback one or more of the purchased media selections. If at step 412 the user decides not to playback any media files, then the process may resolve back to step 406 for further browsing and selection of additional media presentations for purchase and download if the user has not finished accessing media. The process could also move directly from step 411 directly to step 416 (log off) if the user has finished downloading but will not play any selections while connected to the host system. Further, the user may disconnect the playback device from the host computer before playing any of the media on the device.

The user may, at step 412, decide to play a media selection downloaded to the device and at step 414 may initiate playback of a specific presentation from the point of the device. The user may playback media on the device whether the device is connected or not to the host computer. A likely sequence is that the user logs off of the service before actually consuming the media but it is not a requirement of the present invention. Downloaded files may be played back while the device is still connected to the host and further may be streamed from a media server in real time while the device is engaged in a Web session through the host.

After a user pays the media selection on the playback device, the user may decide at step 414 if he or she is done playing media on the device. If the user has not finished and is still connected to the host and the network, the process may loop back to step 406 for further media acquisition. At step 415 if the user is done, the user may log-off of the system at step 416 if the user had not logged off and disconnected the playback device after downloading the media but before playing the media.

It will be apparent to one with skill in the art that process steps 400 may include fewer or more steps without departing from the spirit and scope of the present invention. Further, the process steps described herein may be arranged in different orders than the specific order of steps presented in this example. Moreover, options for backtracking through the process and jumping from one point in the process to another point in the process may exist in the process without specifically being illustrated herein.

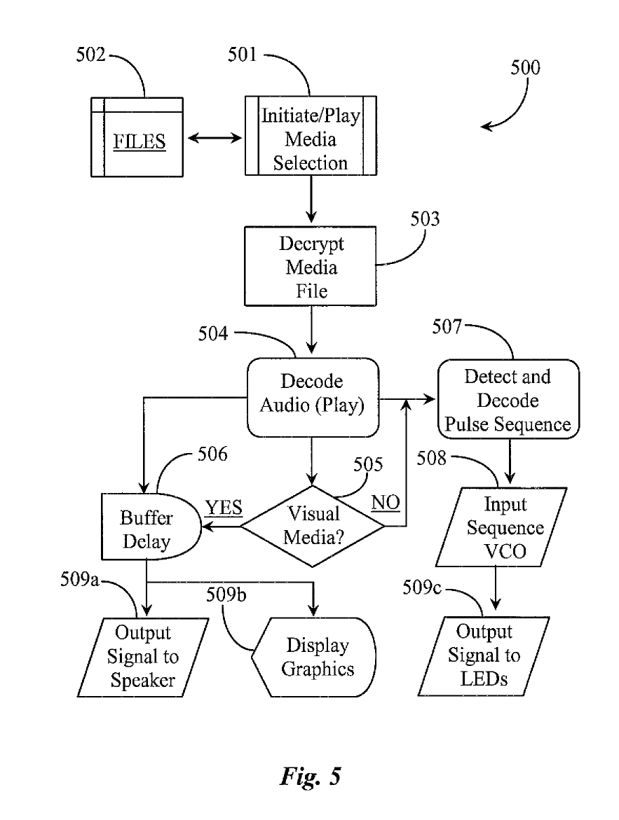

FIG. 5 is a process flow chart illustrating steps 500 for playing a media selection using device 114 of FIG. 2A. At step 501a user initiates the play command relative to a selected media presentation. At step 502 the playback device retrieves the presentation files from storage to play the selection. Storage may be onboard the device or external to the device and connected to the device like a USB flash device or an SD card.

At step 503 decryption software on the device may be accessed to decrypt an encrypted media selection before playback. All media presentations may be stored in an encrypted format so that other devices cannot access and play the files. In one embodiment, the files may not be stored in an encrypted format and therefore step 503 may not be required.

At step 504 the software player loaded on the media device decodes and plays the media selection. It is important to note herein that the player may also be able to play other media file formats such as Motion Picture Engineering Group (MPEG), AV1, MP3, MOV, and other media file encoding formats. The process branches simultaneously into sequences performed by the player software in the process of playing the media. At step 505 the device determines if there is any visual media like graphics to display. Simultaneously, at step 507, the player detects and decodes any special pulse sequences or patterns used to drive any connected illumination devices. These pulses beats or tones may or may not be a human-audible part of the presentation.

At step 505 if there is no visual media, the process jumps to step 507 on one branch. Audio decoded at step 504 is buffered in step 506 on another branch of the process. If at step 505 there is visual media for display, then that decoded media is also buffered at step 506.

At step 508 the decoded pulse sequence used to control light effects is sent to a VCO and then output to connected LEDs or other illumination devices in step 509c. The buffered audio data is sent as an output audio signal to a connected speaker or speaker set at step 509a and if there is graphics for device display during the presentation it is sent to display at step 509b. One purpose of the delay buffer for normal audio and video is to ensure that the VCO output to the LEDs and the audio visual presentation are all synchronized and experienced by the user correctly. The frequency of LED strobe may be controlled by the voltage output of the VCO and may represent one or more brainwave frequencies such as Alpha, Beta, Theta, or Delta. Synchronization may exist between the audio, video graphics (if present) and the illumination device display such that the user may experience the programmed brain states induced by FFR in a way that also correlates to the audio and any auxiliary visual stimulus.

In one embodiment the eyewear mentioned further above may include one or more peripheral video displays such as in one or both lenses of the eyewear in addition to mounted LEDs that may strobe or increase and decrease in intensity or color or a combination of these while the user can still view the video portion and may sill listen to the audible portion of the presentation.

One with skill in the art of the present invention will agree that more or fewer number of steps 500 may be provided in this process without departing from the spirit and scope of the present invention. One will also agree that inclusion or exclusion of some steps will depend in part on the nature of the media selection being played. For example, step 509b and step 506 for video is not required if there are no graphics at step 505.

It will be apparent to one with skill in the art that the media access and presentation system of the invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

What is claimed is:

1. A system for acquisition and presentation of audio or audio/visual media comprising:
a peripheral computing device including an audio speaker system, a visual display screen and a memory for storing the media, the device having connection access to a computer connected to a network and output connection access to one or more light emitting devices; and
a personalized content page stored in a server connected to the network and accessible to the peripheral computing device, the page including the page content encrypted for use solely by the peripheral computing device;
characterized in that a user operating the device while plugged into the network-connected computer may invoke a universal resource locator on the device to cause navigation to the personalized content page through the network-connected computer as a host.

2. A peripheral computing system for playback of audio or audio/visual media comprising:
a communication port for enabling peripheral device communication with a host computer;
audio/visual media presentation circuitry and software for playing audio files and for displaying graphics;
a memory for storing audio/visual media files; and
one or more device-controlled light emitting devices;
characterized in that a user operating the device may connect to a personalized content page through the host computer and access audio or audio/visual media wherein the audio portion of the media contains pulses set to certain frequencies that are decoded by the device for use in controlling illumination of the one or more light emitting devices.

3. An audio or audio/visual media file comprising:
a sequence of music or sounds; and
one or more sequences of embedded pulses audible or not audible mixed in with the sequence of music or sounds;
characterized in that the embedded pulses occur at one or more frequencies during playback and are electronically detectable by a playback device, the pulses used to drive one or more light emitting devices connected to or accessible to the playback device.

4. A method for controlling one or more illumination devices coupled to or integrated with a hand-held music player by one or more sequences of tones or pulses generated by a digital audio presentation played on the device comprising the steps:
(a) providing a voltage controlled oscillator on the hand-held device as a circuit having a voltage input and a voltage output;
(b) connecting the voltage input of the oscillator to an audio decoder adapted to decode and play the audio presentation;
(c) connecting the voltage output of the oscillator to a power control switch or an intensity control switch that provides power or light intensity control to the one or more illumination devices; and
(d) playing the audio presentation on the hand-held device.

5. A method for conducting a personal media access session through an Internet-connected computer using a peripheral device having a graphics display screen comprising the steps:
(a) establishing a communication link between the peripheral device and the computer;
(b) on the peripheral device, invoking a universal resource locator specific to an electronic information page containing access links to media;
(c) invoking as a result of the action of step (b), the browser on the computer to navigate to and display the electronic information page;
(d) from the peripheral device, selecting from the links in the content page causing download of specific media to the peripheral device; and
(e) after download of the media, terminating the session by controlled action performed from the peripheral device, or by disconnecting the device from the Internet-connected computer.
